(19) United States
(12) Patent Application Publication
(10) Pub. No.: US 2026/0121677 A1
(43) Pub. Date: Apr. 30, 2026

(54) RECEIVER CIRCUIT OPERABLE IN MULTIPLE MODES

(71) Applicant: TEXAS INSTRUMENTS INCORPORATED, Dallas, TX (US)

(72) Inventors: Harsh Bhatt, New Delhi (IN); Sneha Shetty, Bengaluru (IN)

(21) Appl. No.: 18/926,717

(22) Filed: Oct. 25, 2024

(51) Int. Cl. H04B 1/18; H04B 1/16

(52) U.S. Cl. CPC H04B 1/18; H04B 1/1607

(57) ABSTRACT

Receiver circuits, integrated circuits containing such receiver circuits, and related methods are described. For example, a receiver circuit includes a first receive signal path comprising first receive circuitry configured with a first set of trigger levels for respective low-to-high and high-to-low transitions of an input signal applied to an input node of the receiver circuit, and a second receive signal path arranged at least in part in parallel with the first receive signal path and comprising second receive circuitry, different than the first receive circuitry, configured with a second set of trigger levels, different than the first set of trigger levels, for the respective low-to-high and high-to-low transitions of the input signal applied to the input node of the receiver circuit. The first and second receive circuitry are configured for selective complementary activation responsive to a control signal applied to a control signal input of the receiver circuit.

### TECHNICAL FIELD

The present disclosure relates to the field of electronic circuits and systems, and more particularly, but not exclusively, to receiver circuits.

### BACKGROUND

Receiver circuits are illustratively utilized as part of input/output (I/O) circuitry in an integrated circuit, and in numerous other applications. Such receiver circuits in some applications receive input signals from other integrated circuits and/or from other external components of an electronic system.

### SUMMARY

The present disclosure describes receiver circuits operable in multiple modes. This summary is not an extensive overview of the disclosure. Rather, a purpose of the summary is to present some examples of the present disclosure in a simplified form as a prelude to a more detailed description that is presented later.

In some examples, a receiver circuit includes a first receive signal path comprising first receive circuitry configured with a first set of trigger levels for respective low-to-high and high-to-low transitions of an input signal applied to an input node of the receiver circuit, and a second receive signal path arranged at least in part in parallel with the first receive signal path and comprising second receive circuitry, different than the first receive circuitry, configured with a second set of trigger levels, different than the first set of trigger levels, for the respective low-to-high and high-to-low transitions of the input signal applied to the input node of the receiver circuit. Each of the first and second receive circuitry has a receive signal input coupled to the input node of the receiver circuit and an output coupled to an output node of the receiver circuit. The first and second receive circuitry are configured for selective complementary activation responsive to a control signal applied to a control signal input of the receiver circuit.

In some other examples, an integrated circuit comprises a plurality of receiver circuits, and additional circuitry coupled to the plurality of receiver circuits. At least one of the receiver circuits comprises a first receive signal path comprising first receive circuitry configured with a first set of trigger levels for respective low-to-high and high-to-low transitions of an input signal applied to an input node of the receiver circuit, and a second receive signal path arranged at least in part in parallel with the first receive signal path and comprising second receive circuitry, different than the first receive circuitry, configured with a second set of trigger levels, different than the first set of trigger levels, for the respective low-to-high and high-to-low transitions of the input signal applied to the input node of the receiver circuit. Each of the first and second receive circuitry has a receive signal input coupled to the input node of the receiver circuit and an output coupled to an output node of the receiver circuit. The first and second receive circuitry are configured for selective complementary activation responsive to a control signal applied to a control signal input of the receiver circuit.

In some additional examples, a method of manufacturing an integrated circuit comprises forming a plurality of receiver circuits, and forming additional circuitry, wherein the plurality of receiver circuits are coupled to the additional circuitry. Forming each of one or more of the receiver circuits comprises forming a first receive signal path comprising first receive circuitry configured with a first set of trigger levels for respective low-to-high and high-to-low transitions of an input signal applied to an input node of the receiver circuit, and forming a second receive signal path arranged at least in part in parallel with the first receive signal path and comprising second receive circuitry, different than the first receive circuitry, configured with a second set of trigger levels, different than the first set of trigger levels, for the respective low-to-high and high-to-low transitions of the input signal applied to the input node of the receiver circuit. Each of the first and second receive circuitry has a receive signal input coupled to the input node of the receiver circuit and an output coupled to an output node of the receiver circuit.

### BRIEF DESCRIPTION OF THE DRAWINGS

FIG. 1 shows a receiver circuit operable in multiple modes in accordance with examples of the present disclosure;

FIG. 2 is a block diagram of an integrated circuit that includes a plurality of receiver circuits and additional circuitry in accordance with examples of the present disclosure;

FIG. 3 is a schematic diagram of an implementation of a Schmitt trigger portion of the FIG. 1 receiver circuit in accordance with examples of the present disclosure;

FIG. 4 is a schematic diagram of an implementation of a comparator portion of the FIG. 1 receiver circuit in accordance with examples of the present disclosure;

FIGS. 5 through 9 are respective timing diagrams illustrating operation of a receiver circuit in different operating modes and under different operating conditions in accordance with examples of the present disclosure;

FIG. 10 is a flow diagram illustrating a method of operating a receiver circuit in accordance with examples of the present disclosure; and

FIG. 11 is a flow diagram illustrating a method of manufacturing an integrated circuit comprising a plurality of receiver circuits in accordance with examples of the present disclosure.

### DETAILED DESCRIPTION

The present disclosure is described with reference to the attached figures. The components in the figures are not drawn to scale. Instead, emphasis is placed on clearly illustrating overall features and principles of the present disclosure. Numerous specific details and relationships are set forth with reference to examples of the figures to provide an understanding of the present disclosure. The figures and examples are not meant to limit the scope of the present disclosure to such examples, and other examples are possible by way of interchanging or modifying at least some of the described or illustrated elements. Moreover, where elements of the present disclosure can be partially or fully implemented using known components, certain portions of such components that facilitate an understanding of the present disclosure are described, and detailed descriptions of other portions of such components are omitted so as not to obscure the present disclosure.

As used herein, terms such as “first” and “second” are used to arbitrarily distinguish between the elements such terms describe. Thus, these terms in the description and in the claims are not intended to indicate temporal or other prioritization of such elements. Moreover, terms such as “front,” “back,” “top,” “bottom,” “over,” “under,” “vertical,” “horizontal,” “lateral,” “down,” “up,” “upper,” “lower,” or the like, are used to refer to relative directions or positions of features in devices in view of the orientation shown in the figures. For example, “upper” or “uppermost” can refer to a feature positioned closer to the top of a page than other features. The terms so used are interchangeable under appropriate circumstances such that the examples and illustrations of the technology described herein are, for example, capable of operation in other orientations than those illustrated or otherwise described herein. In the following discussion and in the claims, the terms “including,” “includes,” “having,” “has,” “with,” or variants thereof are intended to be inclusive in a manner similar to the term “comprising,” and thus should be interpreted to mean, for example, “including, but not limited to. ” Further, in some examples, the terms “about,” “approximately,” or “substantially” preceding a value mean +/−10−20 percent of the stated value. Still further, unless otherwise specified, the ordering of steps in the description and in the claims are not intended to limit sequencing of the performance of steps and thus alternate step sequencing is contemplated as appropriate.

Various structures disclosed herein, such as transistors and other semiconductor-based circuitry, or portions and combinations thereof, can be formed using semiconductor process techniques. Layers including a variety of materials can be formed over a substrate (e.g., a semiconductor wafer), for example, using deposition techniques (e.g., chemical vapor deposition, physical vapor deposition, atomic layer deposition, spin coating, plating), thermal process techniques (e.g., oxidation, nitridation, epitaxy), and/or other suitable techniques. Similarly, some portions of the layers can be selectively removed, for example, using etching techniques (e.g., plasma (or dry) etching, wet etching), chemical mechanical planarization, and/or other suitable techniques, some of which may be combined with photolithography steps. The conductivity (or resistivity) of the substrate (or regions of the substrate) can be controlled by doping techniques using various chemical species (which may also be referred to as dopants, dopant atoms, or the like) including, but not limited to, boron, gallium, indium, arsenic, phosphorus, or antimony. Doping may be performed during the initial formation or growth of the substrate (or an epitaxial layer grown on the substrate), by ion-implantation, or other suitable doping techniques.

In some examples, a receiver circuit is configurable to operate in multiple modes as described herein. For example, in a first mode of operation, the receiver circuit is illustratively configured to operate in a manner compliant with a first communication protocol, such as a serial peripheral interface (SPI) protocol or another serial communication protocol, while in a second mode of operation, the receiver circuit is illustratively configured to operate in a manner compliant with a second communication protocol, different than the first communication protocol, such as a power management bus (PMB) protocol and/or a system management bus (SMB) protocol, collectively referred to herein as a PMB/SMB protocol, or another management bus protocol. More particularly, in some examples, a receiver circuit is configured in the first mode of operation to operate in an SPI mode that meets SPI receive interface specifications for low-to-high transition input voltage (VIH), high-to-low transition input voltage (VIL) and hysteresis of <0.7*VDDIO, >0.3*VDDIO and >0.1*VDDIO, respectively, at 50 MHz operation, and is configured in the second mode of operation to operate in a PMB/SMB mode to meet PMB/SMB receive interface specifications for VIH, VIL and hysteresis of <1.35V, >0.8V and >80mV, respectively.

The receiver circuit in some examples provides failsafe operation when receiving an input signal with a positive voltage level while the receiver circuit is powered off with an I/O supply voltage (VDDIO) of 0 volts (0V).

Additionally or alternatively, the receiver circuit in some examples provides high input voltage tolerant operation when powered on with a designated VDDIO supply voltage and receiving an input signal with a magnitude greater than the VDDIO supply voltage. For example, such a receiver circuit is illustratively configured to handle a 5 volt (5V) input signal while powered on with a VDDIO supply voltage of 3 volts (3V), in a manner that prevents damage to the receiver circuit.

These and other examples provide technical solutions to significant problems of alternative approaches. For example, one or more such examples overcome significant challenges that can otherwise arise in attempting to configure a single receiver circuit to operate in a manner that satisfies the disparate requirements of different sets of receiver interface specifications, such as receiver interface specifications of the SPI and PMB/SMB communication protocols, while also providing failsafe operation when the receiver circuit is powered off (e.g., VDDIO=0V), and high input voltage tolerant operation for relatively high input signal swings (e.g., 5V) when operating at relatively low VDDIO supply voltage levels (e.g., VDDIO=3V). While various described examples may be expected to provide such or similar improvements, no particular result is a requirement of the present disclosure unless explicitly recited in a particular claim.

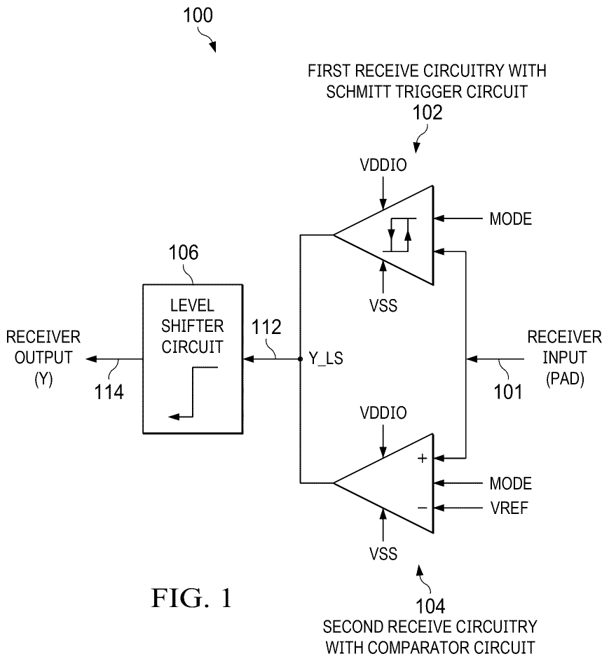

Referring now to FIG. 1, a receiver circuit 100 is configured to receive an input signal applied to an input pad 101. The input pad 101, also denoted herein as simply PAD, represents the receiver input of the receiver circuit 100 in this example. An input signal applied to the input pad 101 is also denoted in some examples herein as a receiver input PAD, to refer to a signal applied to the input pad 101. The input pad 101 is an example of what is more generally referred to herein as an “input node” of the receiver circuit 100.

The receiver circuit 100 comprises a first receive signal path comprising first receive circuitry 102 configured with a first set of trigger levels for respective low-to-high and high-to-low transitions of an input signal applied to the input pad 101 of the receiver circuit 100. The receiver circuit 100 further comprises a second receive signal path arranged at least in part in parallel with the first receive signal path and comprising second receive circuitry 104, different than the first receive circuitry 102, configured with a second set of trigger levels, different than the first set of trigger levels, for the respective low-to-high and high-to-low transitions of the input signal applied to the input pad 101 of the receiver circuit 100.

Each of the first and second receive circuitry 102 and 104 has a receive signal input coupled to the input pad 101 of the receiver circuit 100. Outputs of the respective first and second receive circuitry 102 and 104 are coupled together and to an input of a level shifter circuit 106 of the receiver circuit 100. More particularly, the outputs of the respective first and second receive circuitry 102 and 104 are coupled together at a common output node 112, also denoted as Y_LS, that drives the input of the level shifter circuit 106. An output of the level shifter circuit 106 is coupled to an output node 114 of the receiver circuit 100. The output node 114 is also denoted as receiver output Y. Each of the common output node Y_LS and the receiver output Y is considered an example of an “output node” of the receiver circuit 100, as that term is broadly used herein. The level shifter circuit 106 is therefore coupled between the outputs of the first and second receive circuitry 102 and 104 and the receiver output Y, and couples the common output node Y_LS to the output node corresponding to receiver output Y.

Other types of input and output nodes and at least partially parallel arrangements of first and second receive signal paths comprising respective first and second receive circuitry can be used in other examples.

The level shifter circuit 106 in some examples may be a non-inverting level shifter that is illustratively configured to downconvert the voltage level at common output node Y_LS from I/O supply voltage VDDIO to a core supply voltage VDD at receiver output Y. Other types of non-inverting or inverting level shifters may be used in other examples, and can be implemented in accordance with one or more examples disclosed in U.S. Pat. No. 10,848,156, issued Nov. 24, 2020 and entitled “Voltage Level Shifter,” which is commonly assigned herewith and incorporated by reference herein in its entirety. In examples in which the level shifter circuit 106 is an inverting level shifter, an additional inverter may be coupled in series between the output of the level shifter circuit 106 and the receiver output Y. Other types and arrangements of one or more level shifter circuits can be used in other examples.

The first and second receive circuitry 102 and 104 are configured for selective complementary activation responsive to a control signal applied to a control signal input of the receiver circuit. In the present example, the control signal illustratively comprises a mode signal and the control signal input comprises a mode signal input of the receiver circuit 100. The mode signal is therefore an example of what is more generally referred to herein as a “control signal.” That term as broadly used herein is intended to encompass any of a wide variety of different types and arrangements of one or more mode signals as well as additional or alternative signals or combinations of multiple signals that may be used to modify an operating mode of the receiver circuit 100. The mode signal in the present example is provided to respective mode signal inputs of both the first and second receive circuitry 102 and 104, as shown in FIG. 1.

In some examples, application of the mode signal to the mode signal input of the receiver circuit 100 at a first logic level (e.g., a logic low level) causes activation of the first receive circuitry 102 and deactivation of the second receive circuitry 104. Similarly, application of the mode signal at a second logic level complementary to the first logic level (e.g., a logic high level) causes activation of the second receive circuitry 104 and deactivation of the first receive circuitry 102. Such an arrangement is an example of what is also referred to herein as selective complementary activation of the first and second receive circuitry 102 and 104. Other types of selective complementary activation can be used in other examples. Also, terms such as “activation” and “deactivation” as used herein are intended to be broadly construed, and should not be viewed as requiring that all components of the corresponding first or second receive circuitry 102 or 104 be in the same state or in a particular state at the same time. Instead, activation of one of the first and second receive circuitry 102 and 104 generally indicates that the activated receive circuitry instance is the particular one of the two receive circuitry instances that will be used to process a receiver input signal to generate a receiver output signal in the corresponding mode of operation, while the other one of the receive circuitry instances is inactive and not used to process the receiver input signal to generate the receiver output signal in that mode of operation.

In some examples, the first receive circuitry 102 is configured for operation in accordance with a first communication protocol, such as a serial communication protocol (e.g., an SPI protocol) and the second receive circuitry is configured for operation in accordance with a second communication protocol different than the first communication protocol, such as a management bus protocol (e.g., a PMB/SMB protocol). Accordingly, the first receive circuitry 102 is illustratively activated, and the second receive circuitry 104 is illustratively deactivated, in order to allow the receiver circuit 100 to process a received input signal in a manner that complies with receive interface specifications of the first communication protocol. Similarly, the second receive circuitry 104 is illustratively activated, and the first receive circuitry 102 is illustratively deactivated, in order to allow the receiver circuit 100 to process a received input signal in a manner that complies with receive interface specifications of the second communication protocol, where the receive interface specifications of the second communication protocol are different than those of the first communication protocol in terms of one or more of VIH, VIL and hysteresis. The logic level of the mode signal in the present example controls the complementary activation and deactivation of the first and second receive circuitry 102 and 104. For example, as indicated above, a logic low level of the mode signal illustratively activates the first receive circuitry 102 and deactivates the second receive circuitry 104, and a logic high level of the mode signal illustratively activates the second receive circuitry 104 and deactivates the first receive circuitry 102.

The first receive circuitry 102 in some examples is configured to provide a first amount of hysteresis based at least in part on the first set of trigger levels and the second receive circuitry 104 is configured to provide a second amount of hysteresis, different than the first amount of hysteresis, based at least in part on the second set of trigger levels. The amount of hysteresis is illustratively given by the difference between VIH and VIL.

For example, the first receive circuitry 102 is illustratively configured to provide an amount of hysteresis that varies as a function of a supply voltage applied to a supply voltage terminal of the receiver circuit 100, such as a VDDIO supply voltage, in order to meet receive interface specifications of the SPI protocol, which as indicated above specify VIH, VIL and hysteresis as a function of VDDIO, and more particularly as <0.7*VDDIO, >0.3*VDDIO and >0.1*VDDIO, respectively, for an input signal at a 50 MHz rate of operation. Thus, the VIH, VIL and hysteresis provided by the first receive circuitry 102 when activated illustratively varies as a function of the VDDIO supply voltage. A nominal value for the VDDIO supply voltage in some examples is 3V.

The second receive circuitry 104 in some examples is illustratively configured to provide an amount of hysteresis that is substantially constant as a function of the supply voltage applied to the VDDIO supply voltage terminal of the receiver circuit 100, in order to meet receive interface specifications of a PMB/SMB protocol, which as indicated above specify VIH, VIL and hysteresis independent of VDDIO, and more particularly as <1.35V, >0.8V and >80mV, respectively, for an input signal at a 1 MHz rate of operation. Other communication protocols and VIH, VIL and hysteresis values may be utilized in other examples.

Additionally or alternatively, the first receive circuitry 102 in some examples is configured to provide a first amount of static current draw (e.g., zero static current) and the second receive circuitry 104 is configured to provide a second amount of static current draw that is greater than the first amount of static current draw. For example, the first receive circuitry 102 may provide negligible static current for an input signal at the 50MHz rate of operation, illustratively zero static current, while the second receive circuitry 104 provides a higher amount of static current, such as about 10 to 12 microamps (μA) of nominal static current for an input signal at the 1MHz rate of operation, under certain conditions described below.

In some examples, the second receive circuitry 104 only draws static current when activated, for example, via a mode signal at a logic high level. When the second receive circuitry 104 is activated in this manner, it illustratively draws about 2 μA of bias static current from the VDDIO supply. When an input signal applied to an input node of the receiver circuit 100 is at a logic low level, the activated second receive circuitry 104 draws substantially only the 2 μA of bias static current from the VDDIO supply, and no additional static current. When the input signal applied to the input node of the receiver circuit 100 is at a logic high level, and a current mirror of a comparator in the activated second receive circuitry 104 is turned on in some examples, an additional 10 μA of static current is drawn. Under both of these input signal conditions in some examples, the second receive circuitry 104 draws a greater amount of static current than the first receive circuitry 102 would draw if the latter were instead activated. As indicated above, the first receive circuitry 102 in some examples illustratively draws zero static current, but draws some transient current on input signal transitions, when the first receive circuitry 102 is activated and the applied input signal is switching from logic low to logic high and vice versa.

Other static current values can be provided by the first and second receive circuitry 102 and 104 for other input signal rates and configurations in other examples. For example, the static and transient current draw in a given example will generally vary depending upon the particular circuit components utilized and their associated configurations in the respective first and second receive circuitry 102 and 104.

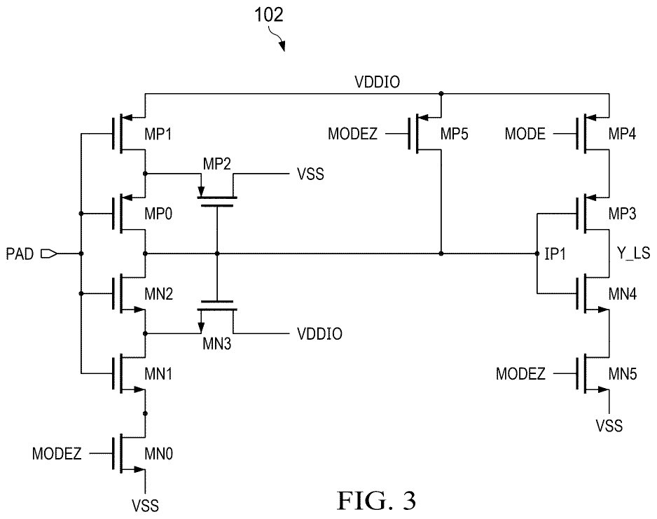

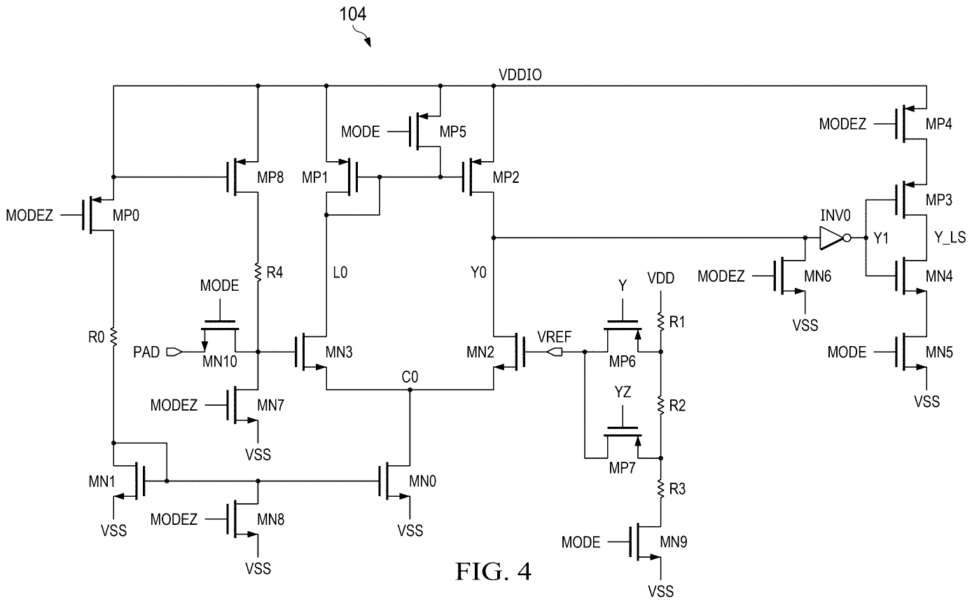

As shown in FIG. 1, the first receive circuitry 102 illustratively comprises a Schmitt trigger circuit, and the second receive circuitry 104 comprises a comparator circuit. The comparator circuit comprises a non-inverting input (+) coupled to the input pad 101 of the receiver circuit 100 and an inverting input (−) coupled to a reference voltage Vref from a reference voltage source of the receiver circuit 100. In some examples, the reference voltage source is implemented as a resistive divider circuit and is implemented within the second receive circuitry 104, although it can be implemented in whole or in part externally to the second receive circuitry 104 in other examples. More detailed examples of the Schmitt trigger circuit and the comparator circuit of the respective first receive circuitry 102 and second receive circuitry 104 are described below in conjunction with the schematic diagrams of respective FIGS. 3 and 4.

In the example of FIG. 1, the receiver circuit 100 includes two different receive signal paths comprising the respective first and second receive circuitry 102 and 104, with selective complementary activation of the first and second receive circuitry 102 and 104 under the control of the mode signal. The mode signal is illustratively a single bit that may be controllably set to a logic low level to place the receiver circuit 100 in the first mode of operation (e.g., an SPI mode of operation), and to a logic high level to place the receiver circuit 100 in the second mode of operation (e.g., a PMB/SMB mode of operation). Additional or alternative operating modes may be used in other examples. Also, receiver circuits in some examples may include more than two distinct operating modes. It is assumed for purposes of illustration in the following description that the first and second modes of operation of the receiver circuit 100 comprise an SPI mode and a PMB/SMB mode, respectively.

In the SPI mode, which in the present example is entered by setting the mode signal to a logic low level, the receiver circuit 100 uses the Schmitt trigger circuit of first receive circuitry 102 to provide VIH, VIL and hysteresis which vary with respect to variation in the supply voltage VDDIO, in order to comply with the receive interface specifications of the SPI protocol. Additional details regarding the operation of an example Schmitt trigger circuit utilized in the first receive circuitry are provided below in conjunction with FIG. 3.

In the PMB/SMB mode, which in the present example is entered by setting the mode signal to a logic high level, the receiver circuit 100 uses the comparator circuit of second receive circuitry 104 to provide VIH, VIL and hysteresis which are substantially fixed with respect to variation in the supply voltage VDDIO, in order to comply with the receive interface specifications of the PMB/SMB protocol. The inverting terminal of the comparator circuit is coupled to a reference voltage Vref from a reference voltage source, such as a resistive divider circuit. The reference voltage is illustratively generated from a core supply, which in some examples is on the order of 1.2V, although other core supply values can be used in other examples. The comparator circuit in some examples is illustratively biased using a current mirror arrangement, and utilizes feedback from its output to toggle between low-to-high and high-to-low transitions at the input pad 101, as will be described in more detail below in conjunction with FIG. 4.

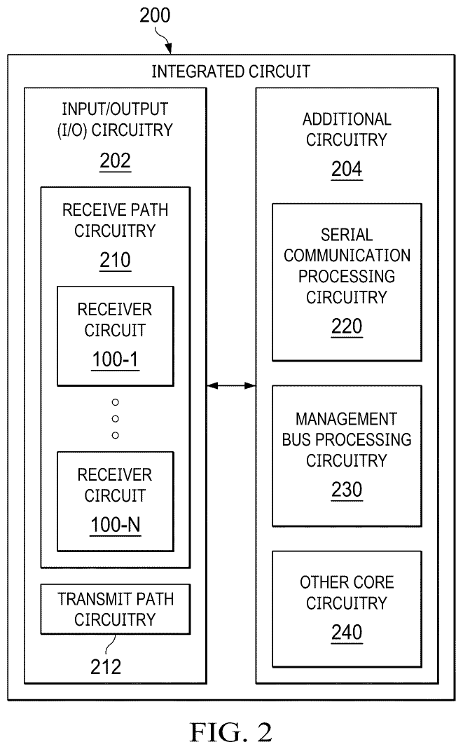

The receiver circuit 100 is illustratively implemented as part of an integrated circuit, examples of which will now be described in more detail with reference to FIG. 2. In other examples, the receiver circuit 100 can be implemented in other ways, such as at least partially in the form of discrete circuit components.

Referring now to FIG. 2, an example integrated circuit 200 is shown. The integrated circuit 200 comprises a plurality of receiver circuits 100-1 through 100-N, each of which is illustratively configured in the manner previously described in conjunction with FIG. 1. The variable N denotes a positive integer greater than one, which may vary depending upon the particular implementation, and in some examples can take on values such as 2, 10, 100, etc. Other types and arrangements of receiver circuits, including one or more receiver circuits configured in a manner different than that illustrated in FIG. 1, can be included in the integrated circuit 200.

The integrated circuit 200 includes input/output (I/O) circuitry 202 and additional circuitry 204 coupled to the I/O circuitry 202. The I/O circuitry 202 further comprises receive path circuitry 210 and transmit path circuitry 212, with the receiver circuits 100-1 through 100-N being implemented as part of the receive path circuitry 210. The additional circuitry 204 in this example includes serial communication processing circuitry 220, management bus processing circuitry 230, and other core circuitry 240. A wide variety of other types and arrangements of circuitry can be implemented within the integrated circuit 200, in addition to the receiver circuits 100-1 through 100-N.

In some examples, at least a subset of the receiver circuits 100-1 through 100-N receive input signals from one or more external devices and/or systems, not shown in FIG. 2, relating to serial communication functionality and/or management bus functionality of the integrated circuit 200, for further processing by the respective serial communication processing circuitry 220 and management bus processing circuitry 230. Additional or alternative input signals of a wide variety of different types may additionally or alternatively be received by at least portions of the receiver circuits 100-1 through 100-N from one or more external devices and/or systems for further processing by the other core circuitry 240. The transmit path circuitry 212 of the I/O circuitry 202 illustratively comprises a plurality of transmitter circuits, not explicitly shown, for providing output signals, resulting from processing performed in the additional circuitry 204, from the integrated circuit 200 to the one or more external devices and/or systems. Numerous other integrated circuits can be configured to include one or more receiver circuits of the type previously described in conjunction with FIG. 1.

FIG. 3 shows an example implementation of first receive circuitry 102 of the receiver circuit 100 of FIG. 1, which is activated in the SPI mode of operation. The first receive circuitry 102 has a receive signal input coupled to the input pad denoted PAD and an output coupled to the common output node denoted Y_LS that drives the level shifter circuit 106 of FIG. 1. The first receive circuitry 102 also has a mode signal input for receiving the mode signal of the receiver circuit 100, denoted as mode, and its complement denoted as modez. The first receive circuitry 102 is activated, and the second receive circuitry is deactivated, responsive to the mode signal being at a logic low level.

The first receive circuitry 102 comprises a Schmitt trigger circuit and an inverter arranged in series between PAD and Y_LS in a first signal path of the receiver circuit 100. The Schmitt trigger circuit has an input coupled to PAD and an output coupled to an input of the inverter at internal node IP1. The output of the inverter is the output node Y_LS that drives the level shifter circuit 106. The Schmitt trigger circuit and the inverter are implemented using P-type field effect transistors (FETs) and N-type FETs, each having gate, source and drain terminals, and more particularly using P-type and N-type metal-oxide-semiconductor (MOS) FETs, also referred to herein as PMOS and NMOS devices, which are illustratively configured in accordance with a complementary MOS (CMOS) arrangement. Other types and arrangements of transistors and other circuit components can be used to implement the Schmitt trigger circuit and inverter of first receive circuitry 102 in other examples.

In the first receive circuitry 102, the Schmitt trigger circuit comprises PMOS devices MP0, MP1 and MP2, and NMOS devices MN1, MN2 and MN3, arranged as shown. The Schmitt trigger circuit is activated by the logic low mode signal, which turns on NMOS device MN0 as modez is at a logic high level. The modez signal is also applied to the gate terminal of PMOS device MP5, which has its source terminal coupled to the VDDIO supply terminal and its drain coupled to the internal node IP1. The inverter comprises PMOS device MP3 and NMOS device MN4. The mode signal is applied to the gate terminal of PMOS device MP4 and its complement modez is applied to the gate terminal of NMOS device MN5.

The devices MP0, MP1, MP2, MN1, MN2 and MN3 are illustratively implemented as 5V MOS devices, and the devices MP3, MP4, MP5, MN0, MN4 and MN5 are illustratively implemented as 3.3V MOS devices, although other MOS device types and configurations can be used in other examples.

In some examples, channel width/length sizing for MP0, MP1, MP2, MP3, MP4 and MP5 in FIG. 3 is illustratively configured as 8/1, 8/1, 4.6/1, 6/0.4, 6/0.4and 5/0.4, respectively, and channel width/length sizing for MN0, MN1, MN2, MN3, MN4 and MN5 in FIG. 3 is illustratively configured as 3.2/1, 2.8/1, 2.8/1, 1.4/1, 1/0.4and 1/0.4, respectively, all in units of micrometers (μm), although other channel width/length sizings can be used in other examples.

In the SPI mode, in which the mode signal is set to a logic low level, the first receive signal path comprising the Schmitt trigger circuit and the inverter of the first receive circuitry 102 is activated via mode switching circuitry comprising PMOS devices MP4 and MP5 and NMOS devices MN0 and MN5. Feedback transistors comprising respective PMOS device MP2 and NMOS device MN3 of the Schmitt trigger circuit provide negative feedback to ensure that the desired amount of hysteresis is provided.

The NMOS device MN0 and the PMOS device MP5 of the mode switching circuitry also serve to ensure that the Schmitt trigger circuit is disabled and the internal node IP1 is pulled high when the receiver circuit 100 is not in the SPI mode of operation.

As indicated above, the Schmitt trigger circuit is followed by the inverter, which is coupled to PMOS device MP4 and NMOS device MN5 of the mode switching circuitry to enable and disable the output at Y_LS responsive to the mode signal. When the mode signal is at a logic low level in the SPI mode, PMOS device MP4 and NMOS device MN5 are both on, thereby enabling the inverter comprising PMOS device MP3 and NMOS device MN4 to drive the level shifter circuit 106 via output node Y_LS. The inverter is disabled when the mode signal is at a logic high level, which turns off MP4 and MN5 of the mode switching circuitry.

FIG. 4 shows an example implementation of second receive circuitry 104 of the receiver circuit 100 of FIG. 1, which is activated in the PMB/SMB mode of operation. The second receive circuitry 104 has a receive signal input coupled to the input pad denoted PAD and an output coupled to the common output node denoted Y_LS that drives the level shifter circuit 106 of FIG. 1. The second receive circuitry 104 also has a mode signal input for receiving the mode signal of the receiver circuit 100, denoted as mode, and its complement denoted as modez. The second receive circuitry 104 is activated, and the first receive circuitry 102 is deactivated, responsive to the mode signal being at a logic high level.

The second receive circuitry 104 comprises a comparator circuit arranged in series with a pair of inverters between PAD and Y_LS in a second signal path of the receiver circuit 100. The comparator circuit comprises PMOS devices MP1 and MP2, and NMOS devices MN0, MN1, MN2 and MN3, arranged as shown. The comparator circuit has a non-inverting input at the gate terminal of MN3 that is coupled to PAD, an inverting input at the gate terminal of MN2 that is coupled to Vref, and an output coupled to an input of a first inverter at internal node Y1 via another inverter INV0. The first inverter comprises the same arrangement of PMOS device MP3 and NMOS device MN4, and associated mode switching circuitry devices MP4 and MN5, as used for the inverter of the first receive circuitry 102 in FIG. 3. The output of the first inverter is the output node Y_LS that drives the level shifter circuit 106. As in the first receive circuitry 102, other types and arrangements of transistors and other circuit components can be used to implement the comparator circuit and inverters of second receive circuitry 104 in other examples.

Like the first receive circuitry 102, the second receive circuitry 104 comprises mode switching circuitry, in this case illustratively including PMOS devices MP0, MP4 and MP5, and NMOS devices MN5, MN6, MN7, MN8, MN9 and MN10. Each of these devices receives at its gate terminal either the mode signal or its complement modez, as shown.

The second receive circuitry 104 further comprises a resistor R0 coupled between the drain terminal of PMOS device MP0 and the drain terminal of NMOS device MN1, as shown. A suitable value for resistor R0 in some examples is 1150kΩ, although other values can be used.

In the second receive circuitry 104, the comparator circuit and first inverter are activated by the logic high mode signal, which turns on NMOS devices MN5, MN9 and MN10 and PMOS devices MP0 and MP4, and turns off NMOS devices MN6, MN7, MN8 and PMOS device MP5.

In the present example, the device MN10 is illustratively implemented as a 5V MOS device, the devices MP6, MP7 and MN9 are illustratively implemented as 1.2V MOS devices, and the remaining PMOS and NMOS devices are illustratively implemented as 3.3V MOS devices, although other MOS device types and configurations can be used in other examples.

In some examples, channel width/length sizing for MP0, MP1, MP2, MP3, MP4, MP5, MP6, MP7 and MP8 in FIG. 4 is illustratively configured as 5/0.4, 2/1, 2/1, 1/0.4, 1/0.4, 5/0.4, 1/0.4, 1/0.4 and 1/1, respectively, and channel width/length sizing for MN0, MN1, MN2, MN3, MN4, MN5, MN6, MN7, MN8, MN9 and MN10 in FIG. 4 is illustratively configured as 10/1, 2/1, 2/1, 2/1, 1/0.4, 1/0.4, 1/0.4, 1/0.4, 1/0.4, 1/0.4 and 15/1, respectively, all in units of micrometers (μm), although other channel width/length sizings can be used in other examples. The inverter INV0 is illustratively formed using an additional PMOS device and an additional NMOS device, each with a channel width/length sizing of 1/0.4.

The 5V NMOS device MN10 is illustratively biased using the VDDIO supply, which may be about 3V in some examples. This arrangement ensures that the gate terminal of NMOS device MN3 does not rise above 3V, as MN3 is illustratively a 3.3V NMOS device in some examples. Again, other MOS device types and configurations can be used.

The second receive circuitry 104 further includes a reference voltage source comprising a resistive divider circuit. The resistive divider circuit comprises resistors R1, R2 and R3 arranged in series between a core voltage supply (VDD) terminal and a drain terminal of NMOS device MN9. The resistive divider circuit further comprises PMOS devices MP6 and MP7 that have their gate terminals coupled to the output Y of the receiver circuit 100 and its complement YZ, respectively, such that the reference voltage Vref provided to the inverting terminal of the comparator circuit by the resistive divider circuit is influenced by feedback from the receiver circuit output Y and its complement YZ. Each of the PMOS devices MP6 and MP7 has its drain terminal coupled to the Vref terminal. The source terminal of MP6 is coupled to a node between R1 and R2, and the source terminal of MP7 is coupled to a node between R2 and R3. Suitable values for R1, R2 and R3 in some examples are 35kΩ, 75kΩ and 590kΩ, respectively, although other values can be used in other examples.

In the PMB/SMB mode, in which the mode signal is set to a logic high level, the second receive signal path comprising the comparator circuit and inverters of the second receive circuitry 104 is activated via the above-noted mode switching circuitry comprising PMOS devices MP0, MP4 and MP5, and NMOS devices MN5, MN6, MN7, MN8, MN9 and MN10.

The operation of the second receive circuitry 104 in the PMB/SMB mode will now be described with reference to low-to-high and high-to-low transitions of the input signal applied to the receiver input at PAD.

For the low-to-high transition, at steady state the output Y of the receiver circuit 100 is initially at a logic low level, and its complement YZ is at a logic high level, such that MP6 is on and MP7 is off, so the reference voltage Vref is set at VDD*(R2+R3)/(R1+R2+R3)=Vref1(<VIH). NMOS device MN2 of the comparator circuit is on and its drain terminal corresponding to node Y0 is pulled to a logic low level through MN2 and MN0. Until PAD reaches Vref1, MN3 is off, which ensures that current mirror PMOS devices MP1 and MP2 are off. Once PAD rises above Vref1, MN3 is turned on, which via node L0 enables the current mirror PMOS devices MP1 and MP2. As PAD rises above Vref1, node C0 of the comparator circuit starts rising because of the constant current through MP1 which eventually turns off MN2 once Vgs<Vth for MN2, and node Y0 is pulled up through MP2. As node Y0 goes to a logic high level, node Y1 goes to a logic low level via inverter INV0, which drives Y_LS to a logic high level via the MP3-MN4 inverter. The level shifter circuit 106 of FIG. 1 receives Y_LS at the logic high level and downconverts from VDDIO to core supply voltage VDD, and the receiver output Y at the output of the level shifter circuit 106 is also at a logic high level.

For the high-to-low transition, at steady state the output Y of the receiver circuit 100 is initially at a logic high level, and its complement YZ is at a logic low level, such that MP6 is off and MP7 is on, so the reference voltage Vref is set at VDD*(R3)/(R1+R2+R3)=Vref2 (>VIL). NMOS device MN3 of the comparator circuit is on and node Y0 is pulled to a logic high level through MP2. Until PAD reaches Vref2, MN3 is on, which ensures that current mirror PMOS devices MP1 and MP2 are on. Once PAD falls below Vref2, MN3 is turned off, which disables the current mirror PMOS devices MP1 and MP2. As PAD falls below Vref2, node C0 of the comparator circuit starts falling which eventually turns on MN2 once Vgs>Vth for MN2, and node Y0 is pulled down to a logic low level. As node Y0 goes to a logic low level, node Y1 goes to a logic high level via inverter INV0, which drives Y_LS to a logic low level via the MP3-MN4 inverter. The level shifter circuit 106 of FIG. 1 receives Y_LS at the logic low level and downconverts from VDDIO to core supply voltage VDD, and the receiver output Y at the output of the level shifter circuit 106 is also at a logic low level.

The second receive circuitry 104 further includes a protective clamp circuit, comprising PMOS device MP8 and resistor R4, which ensures that the voltage at PAD does not exceed the supply voltage VDDIO. In some examples, a suitable value for resistor R4 is about 4kΩ, although other values can be used.

The particular configurations of first and second receive circuitry 102 and 104 as shown in respective FIGS. 3 and 4 are examples only, and additional or alternative circuit elements can be utilized to implement the first and second receive circuitry 102 and 104 in other examples.

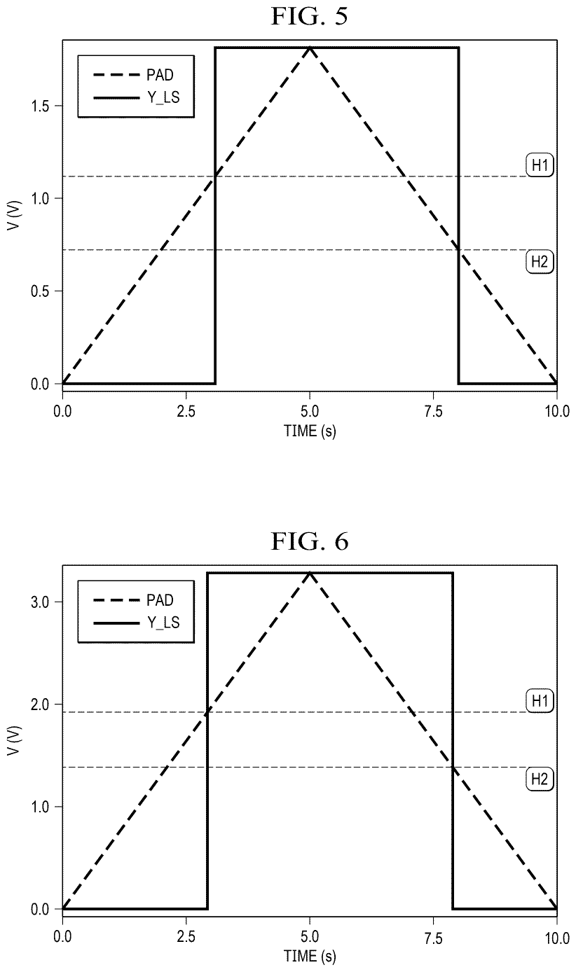

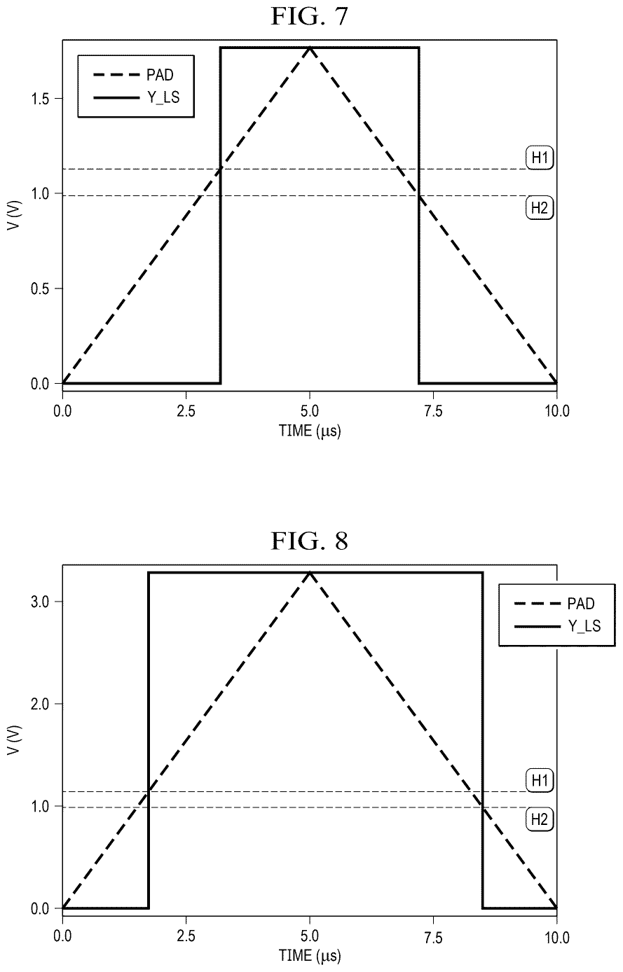

Timing diagrams illustrating operation of a receiver circuit in different operating modes and under different operating conditions in accordance with examples of the present disclosure will be described below with reference to FIGS. 5 through 9. FIGS. 5 and 6 show timing diagrams for the SPI operating mode at different VDDIO supply voltages of 1.8V and 3.3V, respectively, and FIGS. 7, 8 and 9 show timing diagrams for the PMB/SMB operating mode at different input signal magnitudes of 1.8V, 3.3V and 5V, respectively. In each of the timing diagrams, a receiver input signal is superimposed with an output signal at Y_LS, corresponding to the input to the level shifter circuit 106 in the example of FIG. 1. Also, VIH and VIL trigger levels are denoted H1 and H2, respectively, in each timing diagram, with the hysteresis being given by H1-H2.

Referring initially to FIG. 5, a timing diagram shows the receiver input signal applied to input pad 101 of receiver circuit 100, denoted PAD, with the corresponding output signal Y_LS superimposed over the receiver input signal PAD, to illustrate first and second trigger levels VIH and VIL in the SPI mode with a VDDIO supply voltage of 1.8V. For the low-to-high transition, the receiver input signal PAD rises from zero volts until it reaches the VIH trigger level, also denoted as H1. At this point, the output signal Y_LS switches from a logic low level of zero volts to a logic high level of about 1.8V. PAD continues rising until it reaches VDDIO, which is 1.8V in this example. For the high-to-low transition, the receiver input signal PAD falls from about 1.8V until it reaches the VIL trigger level, also denoted as H2. At this point, the output signal Y_LS switches from a logic high level of about 1.8V to a logic low level of zero volts. The difference between VIH and VIL is the hysteresis, denoted Vhyst. In this example, VIH<0.7*VDDIO, VIL>0.3*VDDIO and Vhyst>0.1*VDDIO, such that the SPI specifications are met for the VDDIO supply voltage of 1.8V.

FIG. 6 shows a timing diagram similar to that of FIG. 5 but for operation in the SPI mode with a 3.3V VDDIO supply voltage. It can be seen in this example that VIH and VIL have scaled with the supply voltage, in accordance with the previously-described examples of the first receive circuitry 102. PAD is rising until it reaches VDDIO, which is 3.3V in this example. Also, VIH<0.7*VDDIO, VIL>0.3*VDDIO and Vhyst>0.1*VDDIO, such that VIH, VIL and Vhyst have scaled with the VDDIO supply voltage and the SPI specifications are once again met for the higher VDDIO supply voltage of 3.3V.

FIG. 7 shows a timing diagram for the PMB/SMB mode of operation with 1.8V signaling at PAD. As illustrated, PAD is rising until it reaches VDDIO, which is 1.8V in this example. Also, VIH<1.35V, VIL>0.8V and Vhyst>80 mV, such that the PMB/SMB specifications are met.

FIG. 8 shows a timing diagram for the PMB/SMB mode of operation for 3.3V signaling at PAD. It can be seen that VIH and VIL have not scaled with the supply voltage, in accordance with the previously-described examples of the second receive circuitry 104, but instead remain approximately the same as shown in the previous timing diagram of FIG. 7. As illustrated, PAD is rising until it reaches VDDIO, which is 3.3V in this example. Also, VIH<1.35V, VIL>0.8V and Vhyst>80 mV, such that the PMB/SMB specifications are again met.

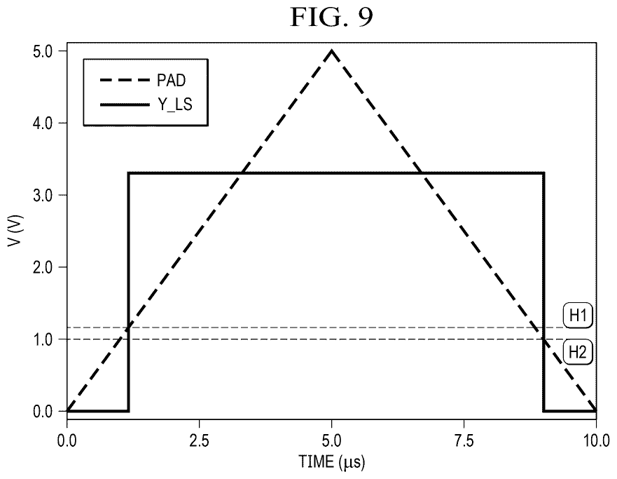

FIG. 9 shows a timing diagram for the PMB/SMB mode of operation for 5V signaling at PAD. It can once again be seen that VIH and VIL have not scaled with the supply voltage, but instead remain approximately the same as shown in the previous timing diagrams of FIGS. 7 and 8. As illustrated, PAD is rising until it reaches 5V, which is above the VDDIO level of 3.3V in this example. Also, VIH<1.35V, VIL>0.8V and Vhyst>80 mV, such that the PMB/SMB specifications are once again met. Other examples similarly meet the PMB/SMB specifications for other values of VDDIO supply voltage, from about 1.6V to about 3.6V.

As described above, some examples provide a receiver circuit with first and second receive circuitry comprising a Schmitt trigger circuit and a comparator circuit, respectively, arranged in parallel with one another in respective first and second receive signal paths, with complementary selective activation controlled by a mode signal, to allow the receiver circuit to support both SPI and PMB/SMB modes of operation. Again, these particular operating modes are examples only, and additional or alternative operating modes can be used in other examples. Also, numerous other arrangements of first and second receive circuitry can be used in receiver circuits as described herein.

As indicated previously, such examples provide technical solutions to significant problems of alternative approaches, by overcoming challenges that can otherwise arise in attempting to configure a single receiver circuit to operate in a manner that satisfies the disparate requirements of different sets of receiver interface specifications, while also providing failsafe operation when the receiver circuit is powered off, as well as high input voltage tolerant operation for relatively high input signal swings when operating at relatively low VDDIO supply voltage levels (e.g., 5V tolerant operation when operating at VDDIO=3V).

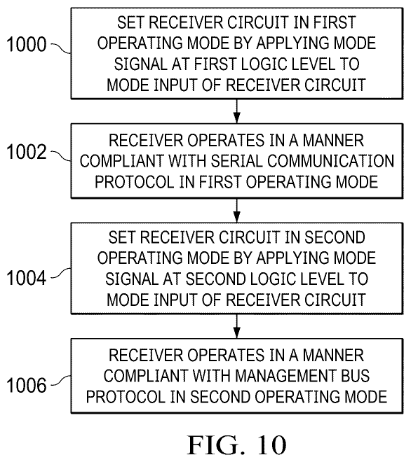

Referring now to FIG. 10, a method of operating a receiver circuit is shown. The method includes steps 1000, 1002, 1004 and 1006, which are illustratively performed with reference to the receiver circuit 100 of FIG. 1, although the same or similar steps can be performed relative to other examples of receiver circuits as described herein. It is assumed that such a receiver circuit includes a first receive signal path comprising first receive circuitry configured with a first set of trigger levels for respective low-to-high and high-to-low transitions of an input signal applied to an input node of the receiver circuit, and a second receive signal path arranged at least in part in parallel with the first receive signal path and comprising second receive circuitry, different than the first receive circuitry, configured with a second set of trigger levels, different than the first set of trigger levels, for the respective low-to-high and high-to-low transitions of the input signal applied to the input node of the receiver circuit, with each of the first and second receive circuitry having a receive signal input coupled to the input node of the receiver circuit and an output coupled to an output node of the receiver circuit, and with the first and second receive circuitry being configured for selective complementary activation responsive to a control signal applied to a control signal input of the receiver circuit.

In the example of FIG. 10, the control signal more particularly comprises a mode signal that is applied to a mode input of the receiver circuit to control switching of the operating mode of the receiver circuit between first and second operating modes. The first operating mode is illustratively a mode compliant with receive interface specifications of a serial communication protocol (e.g., an SPI protocol), and the second operating mode is illustratively a mode compliant with receive interface specifications of a management bus protocol (e.g., a PMB/SMB protocol), although other protocols and control signals can be used in other examples. Also, a receiver in some examples may include additional or alternative operating modes, and is not limited to the particular operating modes utilized in the present example.

In step 1000, a receiver circuit is set in a first operating mode by applying a mode signal at a first logic level (e.g., a logic low level) to a mode input of the receiver circuit. As indicated above, the receiver circuit is illustratively the receiver circuit 100 of FIG. 1.

In step 1002, the receiver circuit operates in a manner compliant with the serial communication protocol in the first operating mode. For example, receiver interface specifications for VIH, VIL and hysteresis of the SPI protocol or other serial communication protocol are met in the first operating mode.

In step 1004, the receiver circuit is set in a second operating mode by applying a mode signal at a second logic level (e.g., a logic high level) to the mode input of the receiver circuit.

In step 1006, the receiver operates in a manner compliant with the management bus protocol in the second operating mode. For example, receiver interface specifications for VIH, VIL and hysteresis of the PMB/SMB protocol or other management bus protocol are met in the second operating mode.

In some examples, steps 1000 through 1006 or portions thereof may be repeated in order to dynamically switch the receiver circuit between the first and second operating modes during operation. In other examples, only steps 1000 and 1002 are performed for a given receiver circuit that is to be configured to operate in the first operating mode on a substantially continuous basis for a given implementation. Similarly, only steps 1004 and 1006 are performed for a given receiver circuit that is to be configured to operate in the second operating mode on a substantially continuous basis for a given implementation. In other words, the operating mode of a given receiver circuit may be substantially continuous for a particular implementation, and need not be dynamically switched between such operating modes during actual operation, although the receiver circuit retains the functionality to support such dynamic switching between multiple modes if and when needed.

Although shown in serial order, the steps of the FIG. 10 method and other methods described herein need not be performed in the particular order shown. For example, certain steps may be performed at least in part in parallel with one another, and additional or alternative steps may be used in other examples.

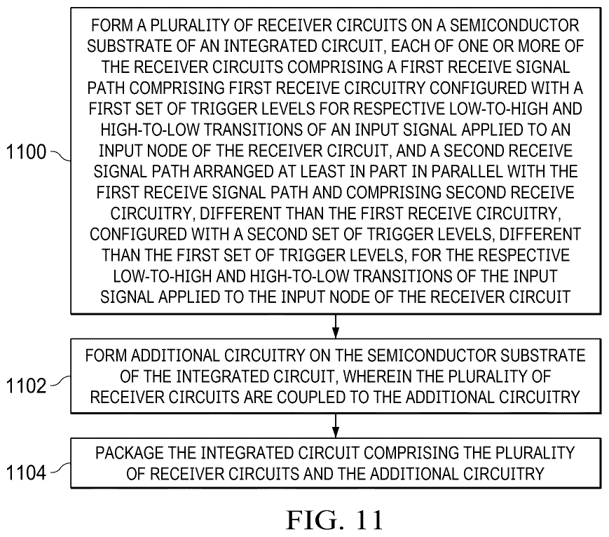

Referring now to FIG. 11, a method of manufacturing an integrated circuit comprising a plurality of receiver circuits is shown. The method includes steps 1100, 1102 and 1104, which are illustratively performed with reference to at least one instance of integrated circuit 200 of FIG. 2, although the same or similar steps can be performed relative to other integrated circuits described herein.

In step 1100, receiver circuits are formed on a semiconductor substrate of an integrated circuit. Forming each of one or more of the receiver circuits illustratively comprises forming a first receive signal path comprising first receive circuitry configured with a first set of trigger levels for respective low-to-high and high-to-low transitions of an input signal applied to an input node of the receiver circuit, and forming a second receive signal path arranged at least in part in parallel with the first receive signal path and comprising second receive circuitry, different than the first receive circuitry, configured with a second set of trigger levels, different than the first set of trigger levels, for the respective low-to-high and high-to-low transitions of the input signal applied to the input node of the receiver circuit. Each of the first and second receive circuitry have a receive signal input coupled to the input node of the receiver circuit and an output coupled to an output node of the receiver circuit.

For example, forming the first and second receive signal paths in some examples comprises forming the first receive circuitry to provide a first amount of hysteresis based at least in part on the first set of trigger levels and forming the second receive circuitry to provide a second amount of hysteresis, different than the first amount of hysteresis, based at least in part on the second set of trigger levels.

In step 1102, additional circuitry is formed on the semiconductor substrate of the integrated circuit, with the plurality of receiver circuits being coupled to the additional circuitry. For example, the additional circuitry can comprise serial communication processing circuitry 220, management bus processing circuitry 230 and/or other core circuitry 240 as shown in FIG. 2.

Such additional circuitry can be formed at least in part concurrently with the formation of the receiver circuits in step 1100. These formation steps illustratively utilize semiconductor process techniques of the type previously described herein.

In step 1104, the integrated circuit comprising the plurality of receiver circuits and the additional circuitry is packaged. For example, in the case of multiple integrated circuits formed on a semiconductor wafer, individual integrated circuits are diced from the wafer. The individual integrated circuits are then each subject to additional operations such as lead frame attachment, wire bonding and encapsulation, and then packaged in an appropriate package such as a single in-line package (SIP), dual in-line package (DIP), quad flat no-lead (QFN) package, dual flat no-lead (DFN) package, chip-on-lead (COL) package, etc.

Again, although shown in serial order, the steps of the FIG. 11 method need not be performed in the particular order shown. For example, certain steps, such as the steps 1100 and 1102 of forming the respective receiver circuits and additional circuitry, may be performed at least in part in parallel with one another, and additional or alternative steps may be used in other examples.

In addition, while in accordance with illustrated implementations, various features or components have been shown as having particular arrangements or configurations, other arrangements and configurations are possible. Moreover, aspects of the present technology described in the context of example implementations may be combined or eliminated in other implementations. Thus, the breadth and scope of the description is not limited by any of the above-described implementations.

What is claimed is:

1. A receiver circuit, comprising:
a first receive signal path comprising first receive circuitry configured with a first set of trigger levels for respective low-to-high and high-to-low transitions of an input signal applied to an input node of the receiver circuit; and
a second receive signal path arranged at least in part in parallel with the first receive signal path and comprising second receive circuitry, different than the first receive circuitry, configured with a second set of trigger levels, different than the first set of trigger levels, for the respective low-to-high and high-to-low transitions of the input signal applied to the input node of the receiver circuit;
each of the first and second receive circuitry having a receive signal input coupled to the input node of the receiver circuit and an output coupled to an output node of the receiver circuit;
wherein the first and second receive circuitry are configured for selective complementary activation responsive to a control signal applied to a control signal input of the receiver circuit.

2. The receiver circuit of claim 1, wherein the control signal comprises a mode signal and the control signal input comprises a mode signal input of the receiver circuit.

3. The receiver circuit of claim 1, wherein application of the control signal to the control signal input at a first logic level causes activation of the first receive circuitry and deactivation of the second receive circuitry and application of the control signal at a second logic level complementary to the first logic level causes activation of the second receive circuitry and deactivation of the first receive circuitry.

4. The receiver circuit of claim 1, wherein the first receive circuitry is configured for operation in accordance with a first communication protocol, and the second receive circuitry is configured for operation in accordance with a second communication protocol different than the first communication protocol.

5. The receiver circuit of claim 1, wherein the first receive circuitry is configured to provide a first amount of hysteresis based at least in part on the first set of trigger levels and the second receive circuitry is configured to provide a second amount of hysteresis, different than the first amount of hysteresis, based at least in part on the second set of trigger levels.

6. The receiver circuit of claim 1, wherein the first receive circuitry is configured to provide an amount of hysteresis that varies as a function of a supply voltage applied to a supply voltage terminal of the receiver circuit and the second receive circuitry is configured to provide an amount of hysteresis that is substantially constant as a function of the supply voltage applied to the supply voltage terminal of the receiver circuit.

7. The receiver circuit of claim 1, wherein the first receive circuitry is configured to provide a first amount of static current draw and the second receive circuitry is configured to provide a second amount of static current draw that is greater than the first amount of static current draw.

8. The receiver circuit of claim 1, wherein the first receive circuitry comprises a Schmitt trigger circuit.

9. The receiver circuit of claim 1, wherein the second receive circuitry comprises a comparator circuit, the comparator circuit comprising a non-inverting input coupled to the input node of the receiver circuit and an inverting input coupled to a reference voltage source of the receiver circuit.

10. The receiver circuit of claim 1, further comprising a level shifter having an input coupled to the outputs of the respective first and second receive circuitry and an output coupled to the output node of the receiver circuit.

11. The receiver circuit of claim 4, wherein the first communication protocol comprises a serial communication protocol.

12. The receiver circuit of claim 11, wherein the serial communication protocol comprises a serial peripheral interface (SPI) protocol.

13. The receiver circuit of claim 4, wherein the second communication protocol comprises a management bus protocol.

14. The receiver circuit of claim 13, wherein the management bus protocol comprises one of a power management bus (PMB) protocol and a system management bus (SMB) protocol.

15. An integrated circuit, comprising:
a plurality of receiver circuits; and
additional circuitry coupled to the plurality of receiver circuits;
wherein at least one of the receiver circuits comprises:
a first receive signal path comprising first receive circuitry configured with a first set of trigger levels for respective low-to-high and high-to-low transitions of an input signal applied to an input node of the receiver circuit; and
a second receive signal path arranged at least in part in parallel with the first receive signal path and comprising second receive circuitry, different than the first receive circuitry, configured with a second set of trigger levels, different than the first set of trigger levels, for the respective low-to-high and high-to-low transitions of the input signal applied to the input node of the receiver circuit;
each of the first and second receive circuitry having a receive signal input coupled to the input node of the receiver circuit and an output coupled to an output node of the receiver circuit;
wherein the first and second receive circuitry are configured for selective complementary activation responsive to a control signal applied to a control signal input of the receiver circuit.

16. The integrated circuit of claim 15, wherein the first receive circuitry is configured for operation in accordance with a first communication protocol, and the second receive circuitry is configured for operation in accordance with a second communication protocol different than the first communication protocol.

17. The integrated circuit of claim 15, wherein the first receive circuitry is configured to provide a first amount of hysteresis based at least in part on the first set of trigger levels and the second receive circuitry is configured to provide a second amount of hysteresis, different than the first amount of hysteresis, based at least in part on the second set of trigger levels.

18. The integrated circuit of claim 15, wherein the first receive circuitry comprises a Schmitt trigger circuit and the second receive circuitry comprises a comparator circuit.

19. A method of manufacturing an integrated circuit, comprising:
forming a plurality of receiver circuits; and
forming additional circuitry;
wherein the plurality of receiver circuits are coupled to the additional circuitry; and
wherein forming each of one or more of the receiver circuits comprises:
forming a first receive signal path comprising first receive circuitry configured with a first set of trigger levels for respective low-to-high and high-to-low transitions of an input signal applied to an input node of the receiver circuit; and
forming a second receive signal path arranged at least in part in parallel with the first receive signal path and comprising second receive circuitry, different than the first receive circuitry, configured with a second set of trigger levels, different than the first set of trigger levels, for the respective low-to-high and high-to-low transitions of the input signal applied to the input node of the receiver circuit;
each of the first and second receive circuitry having a receive signal input coupled to the input node of the receiver circuit and an output coupled to an output node of the receiver circuit.

20. The method of claim 19, wherein forming the first and second receive signal paths comprises forming the first receive circuitry to provide a first amount of hysteresis based at least in part on the first set of trigger levels and forming the second receive circuitry to provide a second amount of hysteresis, different than the first amount of hysteresis, based at least in part on the second set of trigger levels.
